(19) United States
(12) Patent Application Publication
(10) Pub. No.: US 2003/0236593 A1
(43) Pub. Date: Dec. 25, 2003

(54) Method and apparatus for management of distributed heat and power generation

(76) Inventor: Brett L. Schumacher, Woodland Hills, CA (US)

Correspondence Address: CHRISTIE, PARKER & HALE, LLP, P.O. BOX 7068, PASADENA, CA, 91109-7068, US

(21) Appl. No.: 10/177,032

(22) Filed: Jun. 21, 2002

(51) Int. Cl. G05D 3/12

(52) U.S. Cl. 700/291

(57) ABSTRACT

A method and apparatus for the management of distributed power and heat generation. An operations server is coupled to one or more dispatch controllers via a communications network. Each dispatch controller is located at a cogenerator site supplying combined heat and power to a facility such as a building. The dispatch controller is further coupled to generators, chillers, and other power producing and consuming facility equipment. The dispatch controller determines which generators and chillers should be turned on, throttled, and turned off based on economic and regulatory constraints. The dispatch controller receives environmental information, such as the cost of a fuel used to power a generator from the operations server. The dispatch controller further reports facility energy usage and equipment status to a billing server so that the facility's operators may be billed for use of the cogenerator plant.

### REFERENCE TO A SOURCE CODE APPENDIX

The present specification includes an Appendix containing computer source code which is referred to in the specification as APPENDIX B. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The present invention relates generally to controlling the generation of electrical power and more specifically to supervision, control, and data acquisition from, equipment used to generate power and heat in a distributed environment.

Cogeneration plants located at a facility, such as an office building, provide electrical power for satisfaction of the facility's electrical supply needs and thermal energy for use in either directly heating the facility, use in a chiller to cool a the facility, or for other heating needs. These cogeneration plants are generally integrated with the facility's other energy utilities such as a connection to an electrical supply grid or other localized electrical supply such as a photovoltaic array. While the operators of facilities supplied by cogeneration planst enjoy cost savings, a facility owner may not want to manage and maintain a cogeneration plant themselves.

While a third party may be willing to operate a cogeneration plant for a facility, it may be not be economically feasible to operate a large number of disbursed cogeneration plants. For example, stationing dedicated personnel at each cogeneration plant is generally not economically feasible as the profit from each cogeneration plant may not justify full-time staffing. Therefore, personnel maintaining disbursed cogeneration plants may need to travel from cogeneration plant to cogeneration plant in order to reach an economically viable personnel to cogeneration plant ratio. In addition, a cogeneration plant may fail without the knowledge of the maintenance personnel, leading to unacceptable downtime until the maintenance personnel notice the failure while making their scheduled visits to the disbursed cogeneration plants.

### SUMMARY OF THE INVENTION

A method and apparatus for the management of distributed power and heat generation are provided. An operations server is coupled to one or more dispatch controllers via a communications network. Each dispatch controller is located at a cogenerator site supplying combined heat and power to a facility such as a building. The dispatch controller is further coupled to generators, chillers, and other power producing and consuming facility equipment. The dispatch controller determines which generators and chillers should be turned on, throttled, and turned off based on economic and regulatory constraints. The dispatch controller receives environmental information, such as the cost of a fuel used to power a generator from the operations server. The dispatch controller further reports facility energy usage and equipment status to a billing server so that the facility's operators may be billed for consumption of the power and thermal energy generated by the cogenerator site.

In one aspect of the invention, a method is provided for managing power production for a facility over a communications network. A dispatch controller is coupled to a facility power meter for determination of a facility power load and a power generator for generation of power for use by the facility. The facility may be coupled to a power grid from which the facility receives power from a utility when the power supplied by the utility is cheaper than the power supplied by the on-site power generator. The dispatch controller is coupled to an operations server via the communications network. The operations server provides environmental data, such as the cost of fuel, to the dispatch controller. The dispatch controller receives facility power load signals from the facility power meter and a generator fuel supply cost signal from the operations server via the communications network. The dispatch controller then generates a power generator dispatch signal using the facility power load signals and the generator fuel supply cost signal and transmits the power generator dispatch signal to the power generator. The power generator responds to the dispatch signal by either starting or stopping power production for the facility.

In another aspect of the invention, the dispatch control is coupled to a billing server via the communications network and transmits the facility power load signals and the power generator dispatch signal to the billing server. The billing server uses the facility power load signals and the power generator dispatch signal to determine how much the facility's operator should be billed for consumption of the generator's power and thermal output.

In another aspect of the invention, the dispatch controller is used to monitor the status of the power generator. The dispatch controller receives power generator status signals from the power generator and transmits the power generator status signals to the operations server via the communication network. The operations server acts as a system historian by storing the power generator status signals for later analysis.

In another aspect of the invention, the dispatch controller controls the operation of a chiller that uses the waste heat generated by the power generator for facility cooling. The dispatch controller is coupled to a chiller and a facility cooling demand meter and receives a facility cooling demand signal from the facility heat meter. The dispatch controller then generates the power generator dispatch signal by the dispatch controller using the facility power load signals, the generator fuel supply cost signal, and the facility cooling demand signal. In addition, the dispatch controller generates a chiller dispatch signal using the facility power load signals, the generator fuel supply cost signal, and the facility cooling demand signal and transmits the chiller dispatch signal to the chiller.

In another aspect of the invention, a dispatch controller is provided for managing power production for a facility over a communications network. The dispatch controller is coupled via the communications network to an operations server and coupled to a facility power meter, a cogenerator, a facility cooling demand meter, and a chiller. The dispatch controller comprises a processor and a memory operably coupled to the processor with the memory having stored program instructions. The processor is operable to execute the program instructions which implement the features of the dispatch controller. The program instructions include receiving facility power load signals by the dispatch controller from the facility power meter, receiving by the dispatch controller a facility cooling demand signal from the facility cooling demand meter and receiving a cogenerator fuel supply cost signal by the dispatch controller from the operations server via the communications network. The dispatch controller uses the program instructions to generate a cogenerator dispatch signal and a chiller dispatch signal using the facility power load signals, the facility cooling demand signal, and the cogenerator fuel supply cost signal. The dispatch controller then uses the program instructions to transmit the cogenerator dispatch signal to the cogenerator and transmit the chiller dispatch signal to the chiller.

In another aspect of the invention, the dispatch controller is coupled to a photovoltaic array and a photovoltaic array power meter. The dispatch controller uses the program instructions to receive a photovoltaic array power generation signal from the photovoltaic array power meter and generate a photovoltaic array dispatch signal using the facility power load signals, the photovoltaic array power generation signal, and the cogenerator fuel supply cost signal. The dispatch controller then transmits the photovoltaic array dispatch signal to the photovoltaic array.

### BRIEF DESCRIPTION OF THE DRAWINGS

These and other features, aspects, and advantages of the present invention will become better understood with regard to the following description, appended claims, and accompanying drawings where:

FIG. 1 is a block diagram of a single site installation of a distributed energy information system in accordance with an exemplary embodiment of the present invention;

FIG. 2 is a block diagram of a distributed energy information system where the communication and operational features of a dispatch controller are distributed over multiple controllers;

FIG. 3 is a block diagram depicting a generator controller in accordance with an exemplary embodiment of the present invention;

FIG. 4 is a block diagram of a multisite distributed energy information system in accordance with an exemplary embodiment of the present invention;

FIG. 5 is a software architecture diagram for a dispatch controller in accordance with an exemplary embodiment of the present invention;

FIG. 6 is a process flow diagram of a date and time function used by a dispatch controller in accordance with an exemplary embodiment of the present invention;

FIG. 7 is a process flow diagram of a net facility load function used by a dispatch controller in accordance with an exemplary embodiment of the present invention;

FIG. 8 is a process flow diagram of a throttle-down threshold function used by a dispatch controller in accordance with an exemplary embodiment of the present invention;

FIG. 9 is a process flow diagram of an absorptive chiller start function used by a dispatch controller in accordance with an exemplary embodiment of the present invention;

FIG. 10 is a process flow diagram of an engine start function in accordance with an exemplary embodiment of the present invention;

FIG. 11 is a pseudocode listing of an internal combustion engine diagnostics function used by a dispatch controller in accordance with an exemplary embodiment of the present invention;

FIG. 12 is a pseudocode listing of an absorptive chiller modulation function as used by a dispatch controller in accordance with the present invention;

FIG. 13 is a pseudocode listing of the continuous operation mode of a dispatch function as used by a dispatch controller in accordance with an exemplary embodiment of the present invention;

FIG. 14 is a hardware architecture diagram for a dispatch controller in accordance with an exemplary embodiment of the present invention;

APPENDIX A is a pseudocode listing of the functions of a dispatch controller in accordance with an exemplary embodiment of the present invention; and

APPENDIX B is a C code listing of the functions of a dispatch controller in accordance with an exemplary embodiment of the present invention.

### DETAILED DESCRIPTION OF THE INVENTION

Some facilities contract out the management of their cogeneration plants to other parties. These other parties, or operators, install cogeneration plants at multiple sites, thus creating a distributed energy system or a virtual utility network, and assume the day-to-day management of the distributed energy system. The management of the distributed energy system may require collection of accurate information to assess various performance metrics, monitor the operation of the cogeneration plants, and bill the facilities for the operator's services.

The distributed energy system may also employ various distributed energy technologies that operate in parallel with the power grid such as photovoltaic (PV) arrays, microturbines and gas powered internal combustion engines (ICEs) with heat recovery capability. Generally though, the requirements for one facility do not affect requirements for the next as the facilities operate in isolation from each other, providing the benefits of a diverse portfolio for the operator and also achieving economies of scale for items such as fuel procurement. At a site, an operator may have both PV arrays, microturbines, and ICEs with heat recovery to run an absorption chiller and a facility hot water supply.

The decision as to when to start a piece of cogeneration equipment may be complex. For example, a regulatory environment may constrain the allowable parameters for operation of a cogeneration site. In addition, operational variables may vary at individual sites. Some of the operational variables are: applicable tariff schedules; facility power load during off-peak periods; and facility thermal energy demand during shoulder heating and cooling periods. Also, fluctuations in weather, operations and maintenance, user risks, and fuel prices may affect profitability of a cogeneration plant on a daily basis, thus affecting the decision of whether to start or stop a piece of cogeneration equipment, known as dispatching, on a given day.

As an example of the complexity of determining which equipment to dispatch, consider a hypothetical power park including a fossil fuel powered microturbine, an ICE for cogeneration, and a PV array, all operating on economic dispatch to serve a facility on a fixed retail tariff. The dispatch rules may be the same, with a few exceptions, on any given day: the PV array would always be dispatched; the ICE and the microturbine would compete for dispatch based on thermal efficiency. Whichever piece of equipment was more efficient is dispatched when the building load (net of PV supply) exceeds the ICE's or microturbine's nameplate power output, plus some margin. Thus, the equipment would then operate at 100% output. If the facility load is reduced, the power generation may follow the facility load down to a point where it is no longer profitable to run the ICE or microturbine (based on heat rate) or until the equipment's heat rate was lower than the other fossil fuel supplied equipment. If the heat rate dropped below the heat rate of the other equipment and the other were sized appropriately, the other equipment could be dispatched if its operation, according to the customer tariff, were still profitable. In addition, fossil fuel prices may rise above a threshold of profitability, or a host customer's bill might be higher with on-site generation than without.

Therefore, an operator may choose to use a Distributed Energy Information System (DEIS) to manage the distributed energy system.

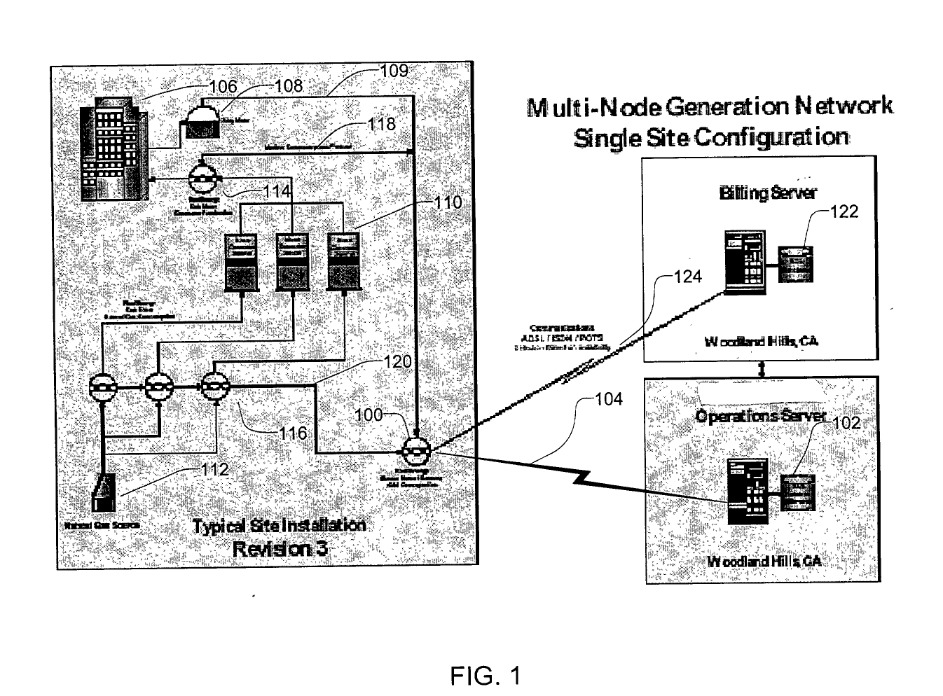

FIG. 1 is a block diagram of an single site installation of a distributed energy information system in accordance with an exemplary embodiment of the present invention. A dispatch controller 100 is operably coupled to an operations server 102 via communications network 104. The dispatch controller is further coupled to a facility 106, such as a building, via a power meter 108, and to one or more power generators 110. The power generators are supplied by a fuel source, such as a natural gas source 112, and convert the fuel source into power for use by the facility. In operation, the dispatch controller receives facility energy usage signals 109 from the power meter and power generator cost of operation signals from the operations server. The dispatch controller uses the power usage signals and the cost of operation signals to determine if a power generator should be started to supply power to the facility.

The dispatch controller is further coupled to one or more power generator power meters 114 and one or more fuel supply meters 116. Once a power generator has been started, the dispatch controller receives power generator production signals 118 and power generator fuel usage signals 120 from the power generator power meters and power generator fuel supply meters respectively. The dispatch controller transmits these signals to a billing server 122 via a communications link 124. The billing server uses the power generator fuel usage and power generator production signals to generate a bill for the power supplied by the power generators.

In an embodiment of a power generator in accordance with the present invention, the power generator is a photovoltaic (PV) array.

In another embodiment of a power generator in accordance with the present invention, the power generator is a cogenerator, producing electrical power for the facility and thermal energy, such as heated water, for other uses within the facility. For example, the thermal energy may be used to supply hot water for heating purposes or air conditioning using a chiller.

In another embodiment of a dispatch controller in accordance with the present invention, the dispatch controller monitors the operation of the power generators and generates alarm signals when the power generators are not operating properly. These alarm signals are transmitted by the dispatch controller to the operations server via the communications network.

In another embodiment of a dispatch controller in accordance with the present invention, the dispatch controller monitors the operation of the power generators and stops the operation of the power generator if it is no longer economically advantageous to operate the power generator. In another embodiment of a dispatch controller in accordance with the present invention, the dispatch controller also determines if the operation of a power generator is allowed under a regulatory scheme. If it is not allowable to operate the power generator, the dispatch controller terminates the operation of the power generator.

In other embodiments of dispatch controllers in accordance with the present invention, a dispatch controller may communicate with the billing and operations server over a variety of communications networks. For example, a dispatch controller may use a digital communications network such as the Internet or an intranet. In other embodiments, the dispatch controller uses a Plain Old Telephone Service (POTS) to communicate with the billing and operations server.

In one embodiment of a dispatch controller in accordance with an exemplary embodiment of the present invention, the dispatch controller monitors several categories of facility equipment performance parameters. For example, high, low, and average voltage output from a generator both in sum and across all three phases. Voltage unbalances are also recorded. High, low, and mean current across all three phases is recorded. High, low, and mean ampere reactance are recorded from a power meter. Data is also gathered on high, low, and mean power factor lag and lead for the frequency of the supplied alternating current (AC) power. The power, in kilowatts, received from a utility by the facility is recorded along with the quality of the power and its ampere reactance. Data is also collected focusing on harmonic distortions on voltage and currents. The duration, magnitude, cause and time of power sags are recorded as well as their waveforms.

The thermal energy output of the generators and the consumption of the thermal energy by the facility is also recorded. For example, the thermal demand of the facility and the ability of a cogenerator system to meet it is measured by gathering temperatures and control valve settings such as the supply and return temperature data, control valve opening and variable frequency drive fan operation data for a cooling tower and balance radiators. The thermal operation of a cogenerator system is monitored by collection of temperatures and current draws of engine pumps connected to a hot water jacket surrounding an engine suppling motive power to a generator. In addition, an absorption chiller's pumps are monitored as well.

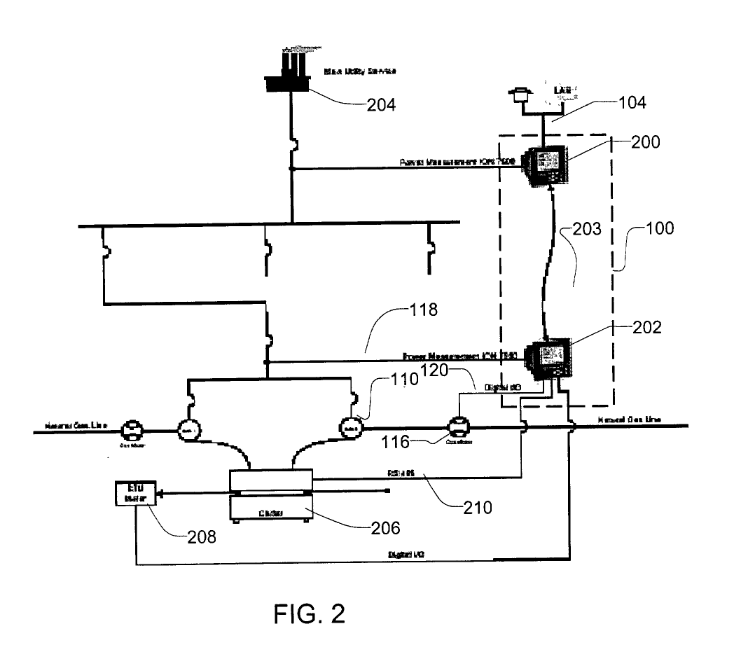

FIG. 2 is a block diagram of a distributed energy information system where the communication and operational features of a dispatch controller are distributed over multiple controllers. In this embodiment, a dispatch controller includes two separate controllers. A gateway controller or gateway meter 200 is coupled to a generator meter or generator controller 202 via a communications link 203. The gateway controller monitors power supplied to a facility by a power utility 204 and handles communications with the previously described billing and operations servers via a communications network 104. The generator controller monitors and controls the operations of one or more power generators 110 and one or more chillers 206. The features of the two controllers are combined to serve as a gateway to the billing and operational servers and provide functions including Integration, Communication, Metering, Monitoring, Billing, Alarm, and Control (ICMMBAC).

Commercially available controllers suitable for use as a dispatch controller are the ION meters supplied by Power Measurement, Limited (PML) of Saanichton, British Columbia, Canada, such as the model PML ION 7500. These meters can serve as gateway devices with the installation of a Local Area Network (LAN) card and they are programmable, thus making them suitable as controllers as well. The generator controller captures generating information and the gateway controller captures information on the main utility bus. Either controller may serve as a gateway device.

The generator controller measures fuel usage of each power generator and provide heat rate calculations based on fuel input and power output. In addition, the generator controller measures other relevant aspects of power generator operation. For example, the generator controller also receives thermal energy flow signals 210 from a BTU meter 208 that measures the thermal energy flow from the chiller to the facility. Temperature data from the BTU meter is transmitted from the gateway controller to a facility control system (not shown).

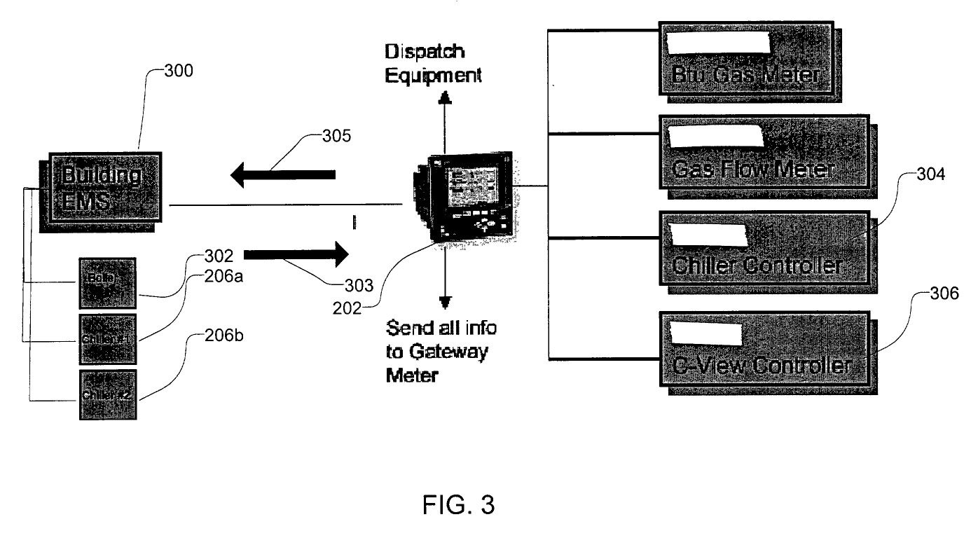

FIG. 3 is a block diagram depicting a generator controller in accordance with an exemplary embodiment of the present invention. A generator controller 202 is coupled to an Energy Management System (EMS) 300. The EMS is coupled to facility equipment in order to monitor and control heating and cooling equipment such as boiler 302 and chillers 206a and 206b. In operation, the generator controller receives facility equipment monitoring signals 303 from the EMS. The generator controller uses these facility equipment monitoring signals to monitor the operation of the facility's heating and cooling equipment by the EMS. The generator controller transmits the facility equipment monitoring signals to the gateway controller 200 (FIG. 2). In a generator controller in accordance with an embodiment of the present invention, the generator controller transmits facility equipment control signals 305 to the EMS to control operations of the facility equipment such as chillers 206a and 206b.

In another generator controller in accordance with an exemplary embodiment of the present invention, the generator controller is coupled to a generator through an intermediate controller such as controller 306. The controller receives generator control signals from the generator controller and transmits generator operational signals back to the generator controller. In a similar manner, the generator controller may be coupled to a chiller through an intermediate chiller controller 304. The generator controller transmits chiller control signals to the chiller controller and receives chiller operational signals from the chiller controller.

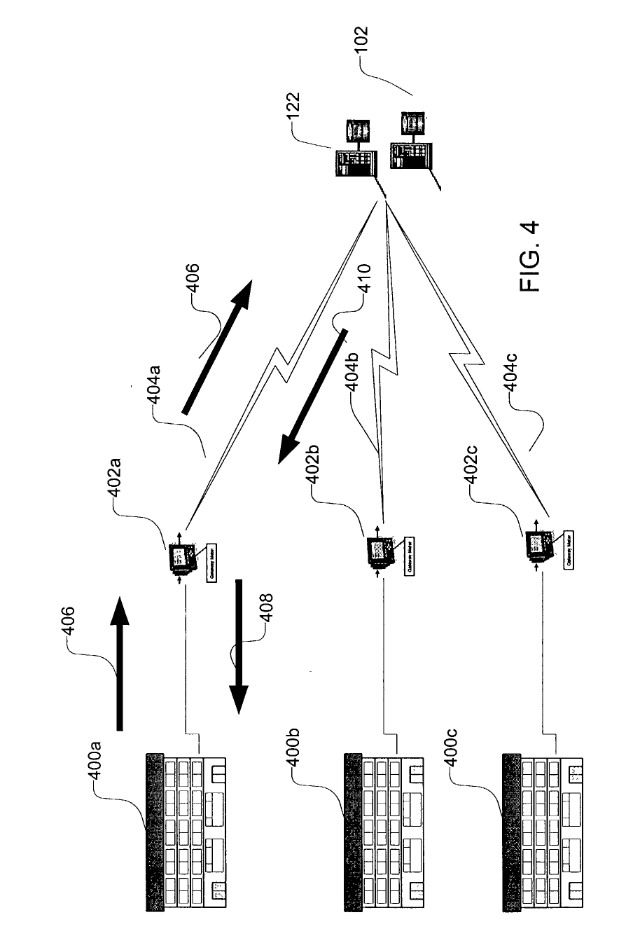

FIG. 4 is a block diagram of a multisite distributed energy information system in accordance with an exemplary embodiment of the present invention. A plurality of facilities, such as facilities 400a, 400b, and 400c, are coupled to a billing server 102 and an operations server 122 via a plurality of dispatch controllers 402a, 404b, and 404c respectively. The dispatch controllers communicate with the billing and operations servers via communication links such as communication links 404a, 404b, and 404c. Each dispatch controller may communicate with the billing and operations servers via a different communications link using different communications protocols as previously described.

In operation, a dispatch controller, such as dispatch controller 402a, receives facility monitoring signals 406 from the heating, cooling, and power metering, and power generation equipment installed in the facility. The dispatch controller retransmits these signals to the billing and operations server. The billing server uses the facility monitoring signals to determine how much the facility operator should be charged for power and thermal energy generation at the facility. The operations server uses the facility monitoring signals to determine how well the facility's equipment is operating. The dispatch controller uses the facility monitoring signals to generate dispatch signals 408 that are transmitted to an EMS, an intermediate controller, or directly to the facility equipment as previously described. In this way, the operations of the plurality of facilities can be monitored from a single billing and operations server.

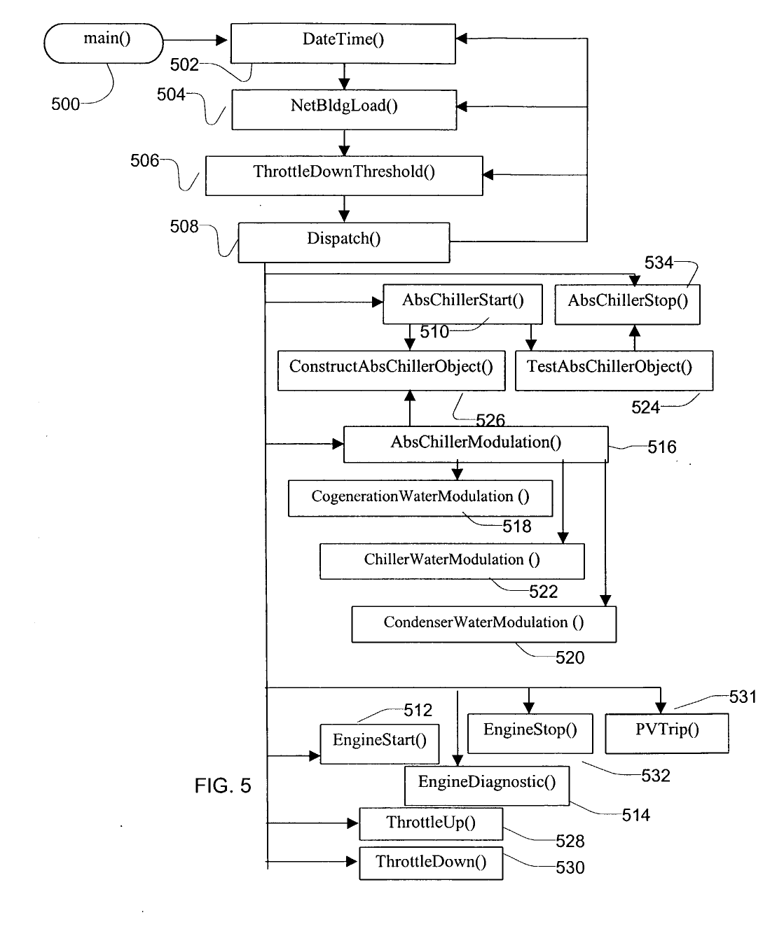

FIG. 5 is a software architecture diagram for a dispatch controller in accordance with an exemplary embodiment of the present invention. A pseudocode listing is included in Appendix A and a source code listing is included in Appendix B of the software modules in the diagram. The contents of Appendix A and Appendix B are hereby expressly incorporated as if fully stated herein.

In the dispatch controller illustrated in FIG. 5, function main 500 starts the program and runs date and time function 502, a net facility load function 504, a throttle-down threshold function 506, and a dispatch function 508. When the dispatch function first runs, the dispatch function checks for an “okay to run” signal from the facility. If the dispatch function receives the go-ahead, the dispatch function runs an absorptive chiller start function 510. When the absorptive chiller start function returns without errors, the dispatch function calls an engine start function 512. When the engine start function returns without errors, the dispatch function calls an engine diagnostic function 514. If on return of control to the dispatch function, engine diagnostic function indicates the engine is operating normally, the dispatch function finishes its start-up operation and goes into continuous operation mode.

In continuous operation mode, the dispatch function launches an absorptive chiller modulation process 516 as a separate program thread that modulates and gathers supply and return temperatures and valve settings from the absorption chiller. The absorptive chiller modulation process uses a cogeneneration water modulation function 518 to control the water flow through the cogeneration plant, a condenser water modulation function 520 to control water flow through the condenser, and a chilled water modulation function 522 to control water flow through the chiller. A test absorptive chiller object 524 is called by a construct absorptive chiller object 526 to ensure that the absorptive chiller modulation process is functioning properly and that the system is running optimally.

Meanwhile, the dispatch function continues to run independently of the absorptive chiller modulation process. When the engine diagnostic function returns to the dispatch function without errors, the dispatch function calls engine throttle-up function 528 and engine throttle-down function 530 to adjust engine outputs to meet operational conditions. In addition, the dispatch function may call a photovoltaic trip function 531 to take a PV array, if any, off-line.

The absorptive chiller modulation process and dispatch function continuously monitor their thermal and electrical systems, respectively. The dispatch function polls the date and time function every 60 minutes, the net facility load function every 1 minute, and the throttle-down threshold function every 60 minutes. The absorptive chiller modulation function watches the cogenerator water modulation function, the condenser water modulation function, and the chilled water modulation function to monitor their respective supply and return temperatures continuously, and to modulate the valves and/or variable frequency controllers or fans to regulate temperatures to keep within their set limits. If the modulation functions encounter a situation which does not improve through their control, they transmit an alarm to the absorptive chiller modulation function, which alarms the dispatch function to call an engine stop function 532 and an absorptive chiller stop function 534 if necessary.

The dispatch function is ultimately responsible for handling all system exceptions either automatically or by alarming for manual decision by personnel. Under normal conditions, the dispatch function continuously calculates thermal credit and rate tariffs, and operates the engine throttle function to maximize system profitability.

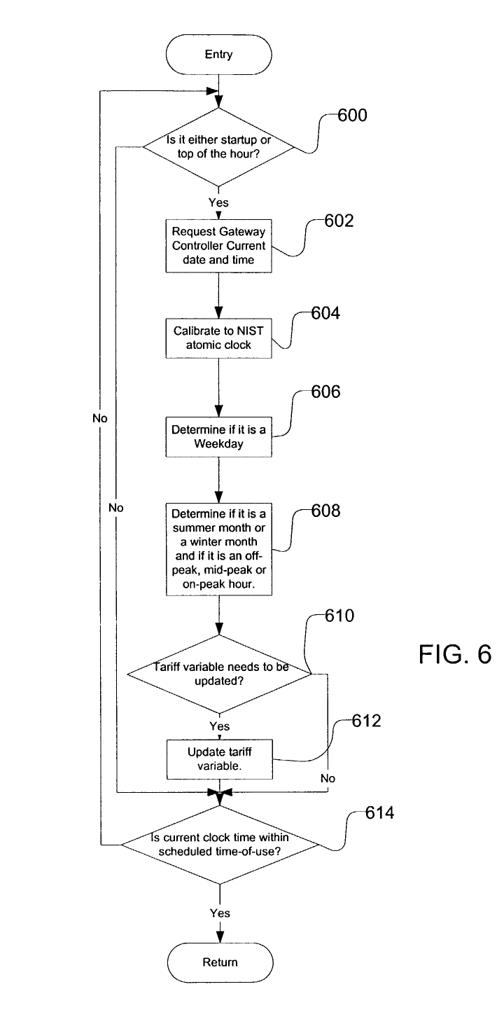

FIG. 6 is a process flow diagram of a date and time function used by a dispatch controller in accordance with an exemplary embodiment of the present invention. The dispatch controller determines (600) if these is either an initial startup or it is the top of the hour. If it is not a startup or a top of the hour, the dispatch controller determines (614) if the current clock time is within a window of scheduled time-of-use. If so, the dispatch controller continues processing to generate a dispatch signal.

If the dispatch controller determines (600) this is a either an initial startup or it is the top of the hour, the dispatch controller requests (602) the current date and time and calibrates (604) its internal time standard to an external time base such as the National Institute of Standards and Technology atomic clock. The dispatch controller determines (606) if the current day is a weekday and whether (608) the current month is a summer or winter month, and if the current hour is an on-peak, mid-peak, or off-peak billing hour. The dispatch controller determines (610) from the weekday, month, and peak period if the tariff rate variable should be updated. If the tariff rate should be updated, the dispatch controller updates (612) the tariff rate variable before continuing.

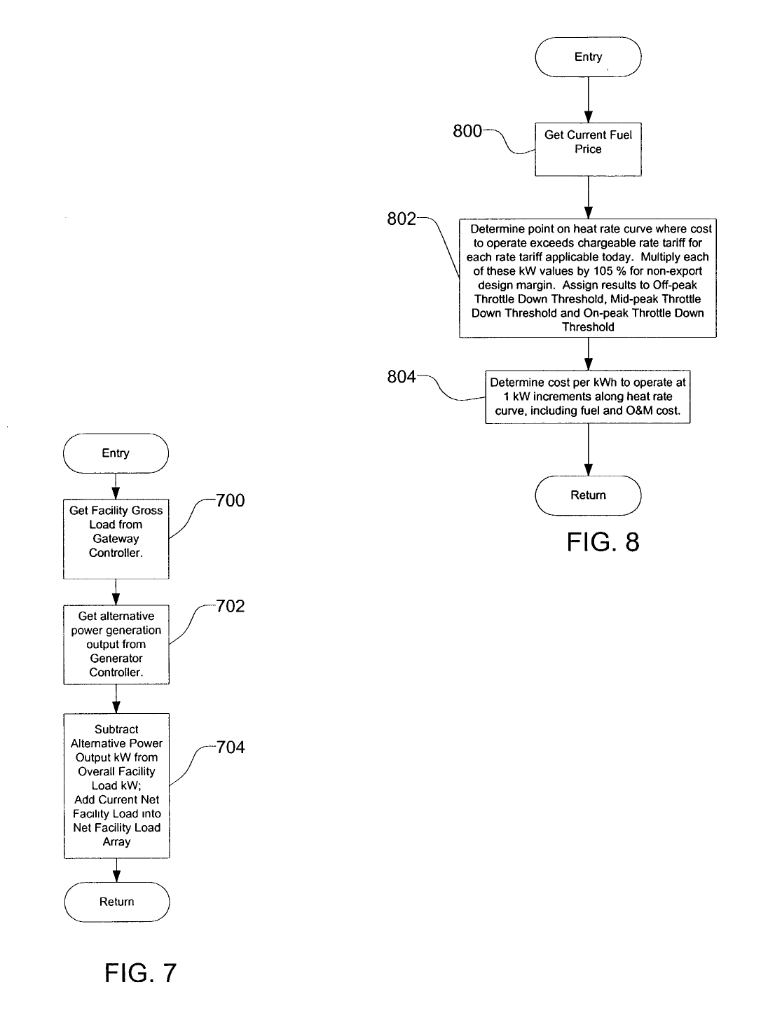

FIG. 7 is a process flow diagram of a net facility load function used by a dispatch controller in accordance with an exemplary embodiment of the present invention. The dispatch controller determines the net facility power load by querying a facility's power meter or EMS as previously described. The facility power load is used by the dispatch controller to determine if a generator can be started. The dispatch controller gets (700) a gross facility load from a gateway controller. The gross facility load may be determined by the gateway controller from reading a facility power meter, such as a utility meter, coupled to the facility as previously described. The dispatch controller also gets (702) the amount of power generated by alternative power sources, such as a PV array, that feed the facility. The dispatch controller determines (704) the net load for the facility by subtracting the amount of power generated by alternative power sources from the gross facility load. The dispatch controller stores the net facility load in a net facility load array for further processing.

Referring again to FIG. 5, the dispatch controller calls a throttle-down threshold function 506 to determine a throttle-down threshold for each a generator. The throttle-down threshold is a measure of the economic feasibility, as a threshold power output value, of operating a generator. A throttle-down threshold function is used by a dispatch controller to determine when the operation of a generator at less than full capacity is no longer economically feasible. The minimum power load that the generator can be operated at is herein termed the throttle-down threshold. If an engine driving a generator operated at a constant heat rate, or thermal efficiency, at all points along the engine's load curve, there may be no need to calculate a throttle-down threshold. However, some engine's heat rate rises at partial loading. This means as the engine output decreases, the amount of fuel needed to produce a unit of power increases. At a certain point, the engine operational cost may exceed the displaced utility electrical tariff and the engine, and thus its coupled generator, will no longer be economical to operate.

The throttle-down threshold may depend on many factors. In some regulatory environments, an operator may be required to ensure that generators do not export power to the power grid. For example, In one regulatory environment, an operator must choose one of three options: 1) a reverse power protective function must be implemented at the generator site with the default setting of 0.1% (export) of transformer rating, with a maximum 2.0 second time delay; or 2) an under-power protective function must implemented at the generator site with a default setting of 5% (import) of DG Gross Nameplate Rating, with a maximum 2.0 second time delay; or 3) or the operator must ensure all of the following conditions are met: a. The aggregate DG capacity of the Generating Facility must be no more than 25% of the nominal ampere rating of the Customer's Service Equipment; b. The total aggregate DG capacity must be no more than 50% of the service transformer rating (This capacity requirement does not apply to customers taking primary service without an intervening transformer); and c. The DG must be certified as non-islanding.

As another example of the complexity of determining threshold values, it may be desirable to operate a generator below the throttle-down threshold if a thermal credit for the use of the cooling water will more than make up the operating loss. In one throttle-down threshold function in accordance with an exemplary embodiment of the present invention, the throttle-down threshold is calculated for each period of the day, both on weekdays and weekend/holidays. When the total building load approaches the throttle-down threshold, the dispatch controller calculates the thermal credit and make a decision on whether to shut down the marginal generator unit or (on weekends during daytime), whether to shut down an alternative power supply such as a PV array. If a second generator's operation is marginal, this decision is likely to shut off the second generator and this event will happen each weekday. In this embodiment, the threshold value depends upon: 1) the price of generator fuel; 2) the cost of operations and maintenance; 3) a design margin; 4) the value of the thermal credit; 5) the applicable tariff; 6) the gross facility load; 7) the strength of the solar day; and 8) the engine heat rate curve. The price of fuel has a significant effect on the throttle-down threshold and can make operation unprofitable at any time of day.

FIG. 8 is a process flow diagram of a throttle-down threshold function used by a dispatch controller in accordance with an exemplary embodiment of the present invention. The dispatch controller gets (800) a current fuel cost from the previously described operations server. The dispatch controller determines (802) a point on the heat rate curve where the cost to operate the generator exceeds the chargeable rate tariff to the facility operator for the power generated by the generator. A throttle-down threshold is generated for each tariff rate that may be charged during a day, such as off-peak, on-peak, and midpeak tariff rates. These power throttle-down threshold levels are then adjusted by a design margin factor to ensure the power generators are operated within the regulatory framework appropriate for the facility's location. The dispatch controller determines (804) the cost per unit of delivered power along the heat rate curve for the generator's engine. These costs include operation and maintenance costs as well as fuel costs. The throttle-down threshold values and operational cost values are stored for later use by the dispatch controller.

Referring again to to FIG. 5, the dispatch controller initiates the operation of the absorptive chiller using an absorptive chiller start function 510. The absorptive chiller is a consumer of the waste heat generated by the cogenerator's engine.

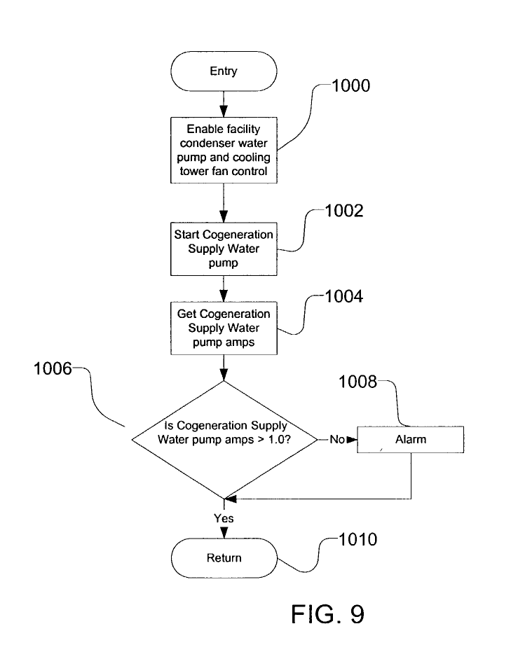

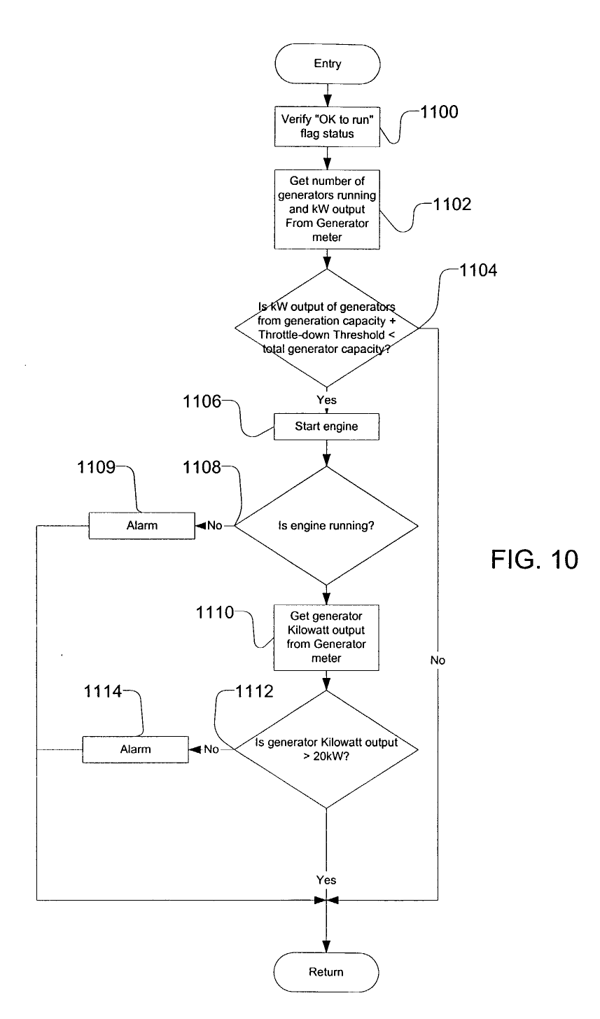

FIG. 9 is a process flow diagram of an absorptive chiller start function used by a dispatch controller in accordance with an exemplary embodiment of the present invention. The dispatch controller enables (1000) the facility condenser water pump and cooling tower fan control. The dispatch controller starts (1002) the generator's supply water pump and gets (1004) the amperage of the current flowing through the supply water pump. The generator determines (1006) if the generator water pump current is greater than 1.0 amp, indicating that the generator water pump is on. If the generator pump is drawing insufficient current, then the dispatch controller indicates an alarm 1008. Otherwise, the absorptive chiller start function returns (1010) control back to the dispatch function of FIG. 5.

In one dispatch controller in accordance with an exemplary embodiment of the present invention, the dispatch controller controls two generators powered by internal combustion engines. One generator is turned on and operated at near full capacity at an economically sound point on the generator's heat rate curve. The second generator is used in a throttling fashion to match the load of the facility.

Referring again to FIG. 5, the dispatch controller starts an engine using the engine start function. The engine start function ensures that the generator site can meet the facility's power demand.

FIG. 10 is a process flow diagram of an engine start function in accordance with an exemplary embodiment of the present invention. In this embodiment of an engine start function, a first engine is started and its operation is confirmed. The dispatch controller verifies (1100) that the “OK to run” flag is true. If so, the dispatch controller gets (1102) the number of engines currently running and the power output from the driven generators. The dispatch controller determines (1104) if starting another generator will successfully meet the load demand. If so, a generator is started (1106). The dispatch controller determines (1108) if the engine driving the generator has actually started and posts an alarm 1109 if the engine has failed to start. If the dispatch controller determines that the engine has indeed started, the dispatch controller gets (1110) the output from the generator driven by the engine. The dispatch controller determines (1112) if the generator output is above a threshold value. If the dispatch controller determines that the generator is not producing enough power, the dispatch controller signals an alarm 1114 and returns to the dispatch. Otherwise, the engine start function returns control to the dispatch function.

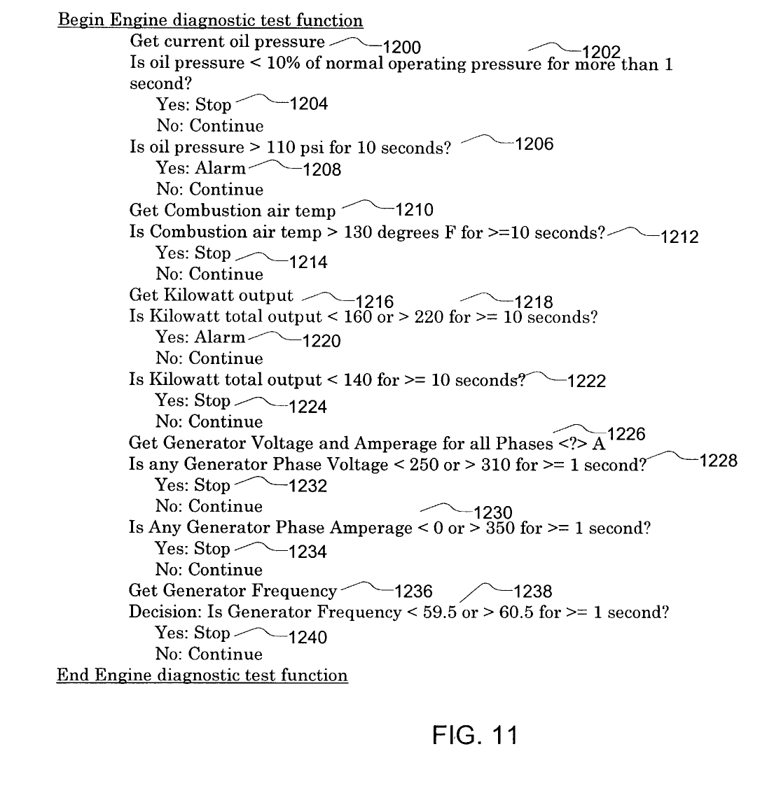

FIG. 11 is a pseudocode listing of an internal combustion engine diagnostics function used by a dispatch controller in accordance with an exemplary embodiment of the present invention. The dispatch controller uses the engine diagnostics function to determine if an engine is operating properly. The dispatch controller gets (1200) the oil pressure of the engine and determines (1202) if the oil pressure is above a threshold value. If the oil pressure is below the threshold value, the dispatch controller stops (1204) the engine, otherwise, the dispatch controller continues to monitor the engine.

If the engine's oil pressure value is above a threshold value, the dispatch controller monitors (1206) the engine for a period of time and determines if the engine's oil pressure is above a threshold value for that period of time. If the engine's oil pressure is above the threshold value for the period of time, the dispatch controller sets an alarm (1208) and returns to the main function of FIG. 5. If the oil pressure of the engine is within acceptable limits, the dispatch controller monitors (1210) a combustion air temperature for the engine for a period of time and determines (1212) if the combustion air temperature is greater than a threshold value for the period of time. If the combustion air temperature is above the threshold value, the dispatch controller stops (1214) the engine.

The dispatch controller gets (1216) the power output of the generator driven by the engine and determines (1218) if the generator power output is within an acceptable limit. If the generator power output is not within acceptable limits, the dispatch controller sets an alarm. If the generator power output is less than a threshold value for more than a set period of time (1222) the dispatch controller stops (1224) the engine.

If the power output of the generator is within acceptable limits, the dispatch controller checks the quality of the power output by getting (1226) the voltage and amperage for all of the generator's electrical phases and checks for an out-of-range phase voltage (1228) or phase amperage (1230). If any phase voltage or amperage is out-of-range, the dispatch controller stops (1232 and 1234) the engine. If the voltage and amperage are within acceptable limits, the dispatch controller gets (1236) the generator frequency and determines (1238) if the generator frequency is within acceptable limits. If the generator frequency is not within acceptable limits, the dispatch controller stops (1240) the engine.

Referring again to FIG. 5, once the absorptive chiller start function 510 the dispatch controller starts the absorptive chiller modulation process for controlling the operation of absorptive chiller.

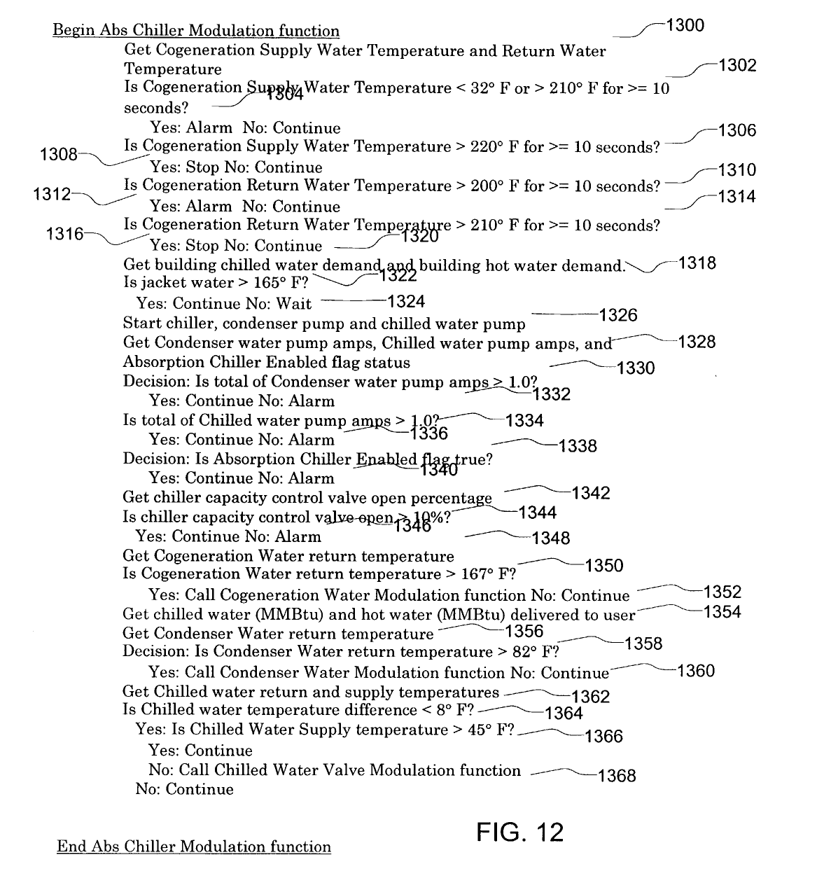

FIG. 12 is a pseudocode listing of an absorptive chiller modulation function as used by a dispatch controller in accordance with the present invention. The dispatch controller gets (1300) the generator supply water temperature and return water temperature. The dispatch controller determines (1302) if the generator supply water temperature is within acceptable operational limits for a specified time period. If not, the dispatch controller sets an alarm (1304). The dispatch controller performs an additional check (1306) to determine if the generator supply water temperature exceeds a threshold limit for a specified period of time. If the generator supply water temperature exceeds the threshold limit, the dispatch controller stops (1308) the operation of the absorptive chiller. The dispatch controller determines (1310) if the generator return water temperature is within acceptable limits for a period of time. If not, the dispatch controller generates an alarm (1312). The dispatch controller performs an additional check (1314) to determine if the generator return water temperature exceeds a threshold value. If so, the dispatch controller stops (1316) the absorptive chiller.

The dispatch controller gets (1320) a chilled water demand value and a hot water demand value for the facility's chillers and hot water heaters. The dispatch controller determines (1322) if the cooling jacket water for the engine is above a threshold temperature value. If the cooling jacket water is below the threshold temperature value, the dispatch controller waits (1324) until the cooling jacket water heats up. The dispatch controller starts (1326) the chiller, condenser pump, and chilled water pump and gets a chiller enabled flag status. The dispatch controller confirms that the water pump is on by getting a electrical current drawn value for the current drawn by the water pump and comparing (1330) the electrical current drawn value to a threshold value. If the electrical current drawn value is less than the threshold value, the dispatch controller sets an alarm 1332. The dispatch controller performs a similar confirmation operation for the chilled water pump (1334) and sets an alarm if it appears that the chilled water pump is not working. The dispatch controller performs an additional chiller status check (1338) and sets an alarm (1340) if the chiller is not enabled.

The dispatch controller confirms that the chiller is operating normally by getting (1342) a chiller capacity value open value and comparing (1344) the opening value to a threshold value. If the chiller capacity valve is not opened above the threshold value, the dispatch controller sets an alarm 1346. The dispatch controller performs a further operational check by getting (1348) a generator water return temperature value and determining (1350) if the if the generator water return temperature value is above a threshold value. If so, the dispatch controller adjusts (1352) the flow of the generator return water. Appendix A includes a pseudocode listing of a generator water modulation function and Appendix B includes a C source listing of the of a generator water modulation function, the contents of which are hereby incorporated by reference as if set forth in full herein.

The dispatch controller gets (1354) the amount of chilled water and heated water in units of total heat delivered to the facility. The dispatch controller transmits this information to the billing server for billing purposes.

The dispatch server gets (1356) a condenser water return temperature and determines (1358) if the condenser water return temperature exceeds a threshold value. If so, the dispatch controller adjusts (1360) the flowrate of the condenser water using a condenser water modulation function as described in Appendix A or in Appendix B.

The dispatch controller gets (1362) a chilled water supply temperature and a chilled water return temperature and determines, in steps 1364 and 1366, if the chilled water supply and return temperatures indicate that the chilled water flowrate needs to be adjusted. If so, the dispatch control calls (1368) a chilled water valve modulation function. A pseudocode listing for a chilled water valve modulation function is described in Appendix A or in Appendix B.

Referring again to FIG. 5, the dispatch controller not only modulates or adjusts the operation of the absorptive chiller but also adjusts the operations of the engines using the dispatch function. The dispatch function determines if the engines driving generators need to be throttled-up or throttled-down. The dispatch function does so by estimating a future net facility load and determining if the generators are operating within their design envelope if they are throttled-up or throttled-down to meet the expected facility load.

Referring again to FIG. 5, the dispatch function has a continuous operation mode where the dispatch function determines the proper choice of generator and alternative energy production mix based on economic considerations.

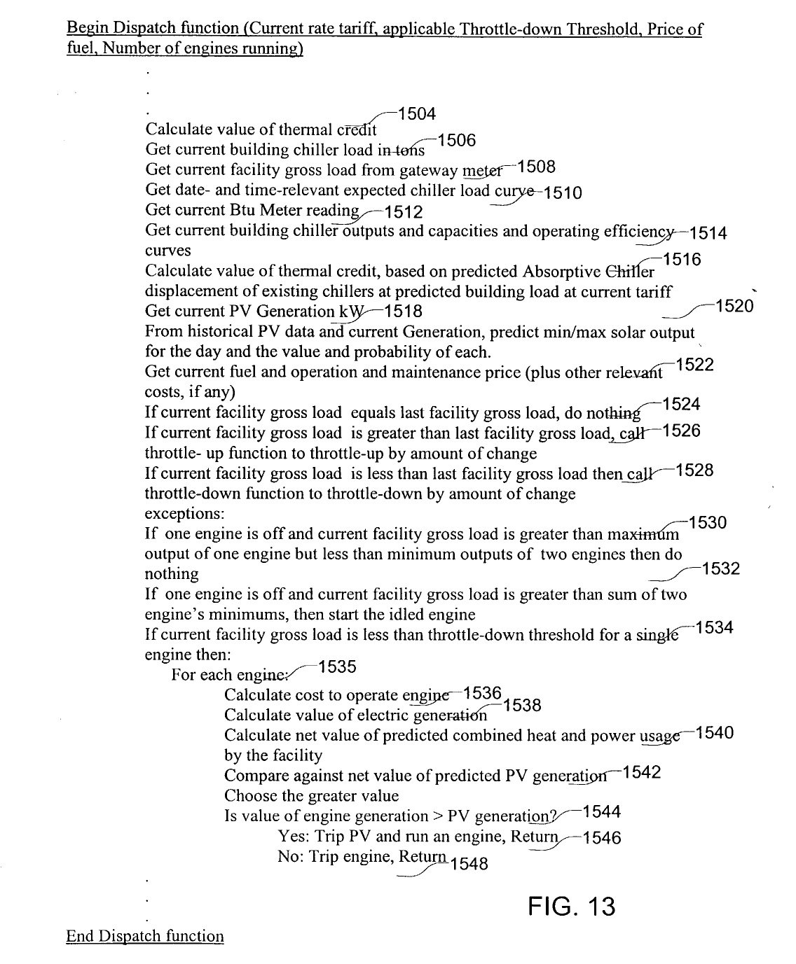

FIG. 13 is a pseudocode listing of the continuous operation mode of a dispatch function as used by a dispatch controller in accordance with an exemplary embodiment of the present invention. The dispatch controller determines (1504) the value of the thermal energy, called the thermal credit, generated by the engine of a running generator. The dispatch controller gets (1506) a current facility chiller load, gets (1508) a current facility gross load, gets (1510) an expected chiller load curve, gets (1512) a current fuel BTU reading, and gets (1514) current building chiller outputs, capacities, and operating curves. The dispatch controller uses these values to calculate (1516) the value of a thermal credit based on the predicted absorptive chiller displacement of existing chillers and predicted facility load at a current power tariff. This is the value of continuing the operation of an engine at below its throttle-down threshold. The dispatch controller gets (1518) the output of any alternative power sources, such as a PV array, and predicts (1520) what the value of the alternative power source for the rest of the day. The dispatch controller gets (1522) the current fuel cost and operation and maintenance costs.

After collecting the current and historical operational date, the dispatch controller determines if any engines need to be either started or stopped. The dispatch controller determines (1524) if the current facility gross load is equal to the previous facility gross load. If so, the dispatch controller doesn't make any changes in the operation of the engines. The dispatch controller determines (1526) if the current facility gross load is greater than the previous facility gross load. If so, the dispatch controller calls a throttle-up function. The dispatch controller determines (1528) if the current facility gross load is less than the previous facility gross load. If so, the dispatch controller calls a throttle-down function. Appendix A includes pseudocode listings for a throttle-up function and a throttle-down function. Appendix B includes source code listings for a throttle-up function and a throttle-down function.

There are exceptions to the above-described throttling logic. If the dispatch controller determines (1530) that one engine is off and the current facility gross load is greater than the maximum output of one engine but less than the sum of the throttle-down thresholds for each engine, then the dispatch controller does nothing. If the dispatch controller determines (1532) that one engine is off and the current facility gross load is greater than the sum of the throttle-down thresholds for each engine, then the dispatch controller starts the idled engine. If the dispatch controller determines (1534) that one engine is off and the current facility gross load is less than the throttle-down thresholds for either engine, then the dispatch controller must determine whether or not running an engine below its throttle-down threshold is economically viable given the thermal credit available to the engine for supplying a chiller with heated water.

To make a determination of whether or not the thermal credit exceeds the cost of running an engine below its throttle-down threshold, for each engine (1535), the dispatch controller calculates (1536) the cost to operate the engine, calculates (1538) the value of the electrical generation, and calculates (1540) the net value of predicted combined heat and power use by the facility. The dispatch controller then determines (1542) if the net value of predicted combined heat and power use by the facility is greater than the net value of the alternative energy source. If so, the alternative power source is turned off (1546) and an engine is either turned on or left on. If not, all of the engines are turned off 1548.

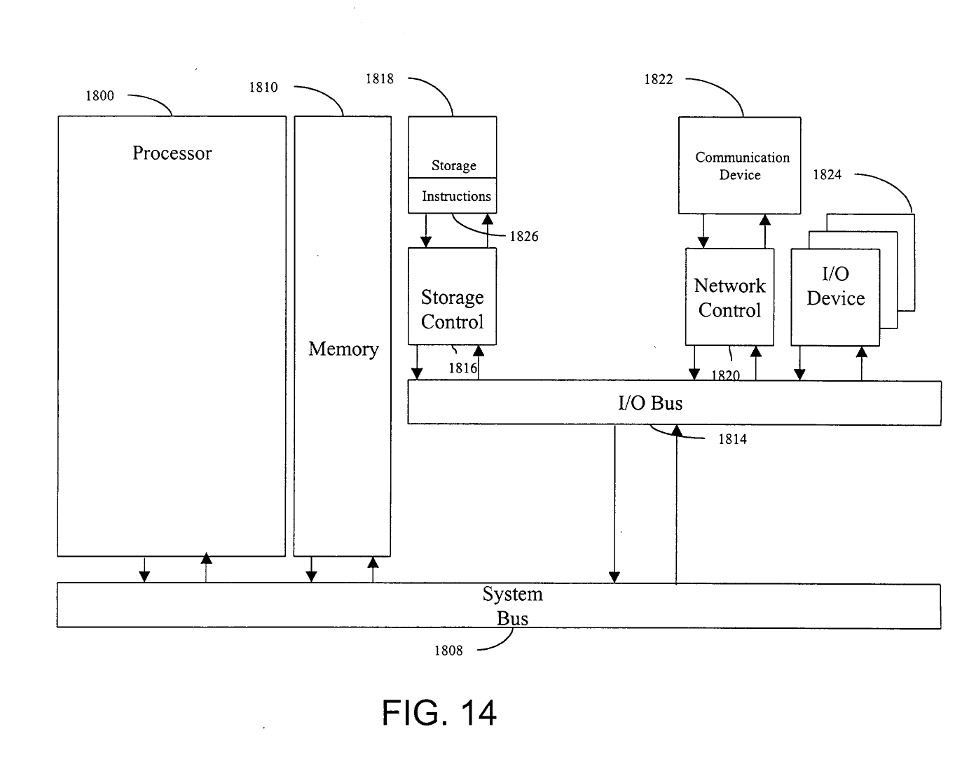

FIG. 14 is an architecture diagram for a dispatch controller in accordance with an exemplary embodiment of the present invention. A processor 1600 is operatively coupled via an Input/Output (I/O) bus to a memory 1610, a storage controller 1816, a network device 1820, and one or more I/O devices 1824.

The storage controller is operatively coupled to a storage device 1818. Computer program instructions 1826 for implementing the features of a dispatch controller are stored in the storage device until the processor retrieves the computer program instructions and stores them in the memory. The processor then executes the computer program instructions stored in the memory to implement the features of a dispatch controller.

The dispatch controller is coupled to external devices within the facility, such as the previously described power generators, facility heating and cooling equipment, and EMSs, via the one or more I/O devices. In operation, the dispatch controller receives facility energy use and equipment status signals from the external devices via the one or more I/O devices. The dispatch controller uses the facility energy use and equipment status signals to generate equipment dispatch signals as previously described. The dispatch controller then transmits the equipment dispatch signals to the external devices via the one or more I/O devices.

The dispatch controller is coupled to external servers, such as the previously described billing and operational servers, via the network device. In operation, the dispatch controller receives fuel cost signals, as well as other generator site control signals, from the operations server as previously described. In addition, the dispatch controller transmits facility energy use and generator site status signals to the operations server via the network device as previously described. The

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supported by this application and the claims' equivalents rather than the foregoing description.

What is claimed is:

1. A method of managing power production for a facility over a communications network, comprising:
providing a dispatch controller coupled to a facility power meter and a power generator;
providing an operations server operably coupled to the dispatch controller via the communications network;
receiving facility power load signals by the dispatch controller from the facility power meter;
receiving a generator fuel supply cost signal by the dispatch controller from the operations server via the communications network;
generating a power generator dispatch signal by the dispatch controller using the facility power load signals and the generator fuel supply cost signal; and
transmitting the power generator dispatch signal by the dispatch controller to the power generator.

2. The method of claim 1, further comprising:
providing a billing server coupled to the dispatch controller via the communications network; and
transmitting the facility power load signals and the power generator dispatch signal by the dispatch controller to the billing server via the communications network.

3. The method of claim 1, further comprising:
receiving power generator status signals by the dispatch controller from the power generator; and
transmitting the power generator status signals by the dispatch controller to the operations server via the communication network.

4. The method of claim 1, further comprising
coupling the dispatch controller to a facility cooling demand meter;
receiving by the dispatch controller a facility cooling demand signal from the facility heat meter; and
generating the power generator dispatch signal by the dispatch controller using the facility power load signals, the generator fuel supply cost signal, and the facility cooling demand signal.

5. The method of claim 4, further comprising:
coupling the dispatch controller to a chiller;
generating a chiller dispatch signal by the dispatch controller using the facility power load signals, the generator fuel supply cost signal, and the facility cooling demand signal; and
transmitting the chiller dispatch signal to the chiller by the dispatch controller.

6. The method of claim 1, further comprising:
coupling the dispatch controller to an alternative power source and an alternative energy power meter;
receiving an alternative energy power generation signal;
generating an alternative power source dispatch signal by the dispatch controller using the facility power load signals, the alternative energy power generation signal, and the generator fuel supply cost signal; and
transmitting the alternative power source dispatch signal to the alternative power source.

7. The method of claim 1, wherein the generator includes a microturbine.

8. A method of managing power production for a facility over a communications network, comprising:
providing a dispatch controller coupled to a facility power meter, a cogenerator, a facility cooling demand meter, and a chiller;
providing an operations server operably coupled to the dispatch controller via the communications network;
receiving facility power load signals by the dispatch controller from the facility power meter;
receiving by the dispatch controller a facility cooling demand signal from the facility cooling demand meter;
receiving a cogenerator fuel supply cost signal by the dispatch controller from the operations server via the communications network;
generating a cogenerator dispatch signal by the dispatch controller using the facility power load signals, the facility cooling demand signal, and the cogenerator fuel supply cost signal;
generating a chiller dispatch signal by the dispatch controller using the facility power load signals, the cogenerator fuel supply cost signal, and the facility cooling demand signal;
transmitting the cogenerator dispatch signal by the dispatch controller to the cogenerator; and
transmitting the chiller dispatch signal to the chiller by the dispatch controller.

9. The method of claim 8 wherein the cogenerator includes and internal combustion engine.

10. The method of claim 8, further comprising:
coupling the dispatch controller to a photovoltaic array and a photovoltaic array power meter;
receiving a photovoltaic array power generation signal by the dispatch controller from the photovoltaic array power meter;
generating a photovoltaic array dispatch signal by the dispatch controller using the facility power load signals, the photovoltaic array signal, and the cogenerator fuel supply cost signal; and
transmitting the photovoltaic array dispatch signal to the the photovoltaic array.

11. A dispatch controller for managing power production for a facility over a communications network, the dispatch controller coupled via the communications network to an operations server and coupled to a facility power meter and a power generator, comprising:
a processor; and
a memory operably coupled to the processor and having program instructions stored therein, the processor being operable to execute the program instructions, the program instructions including:
receiving facility power load signals by the dispatch controller from the facility power meter;
receiving a generator fuel supply cost signal by the dispatch controller from the operations server via the communications network;
generating a power generator dispatch signal by the dispatch controller using the facility power load signals and the generator fuel supply cost signal; and
transmitting the power generator dispatch signal by the dispatch controller to the power generator.

12. The dispatch controller of claim 11, the dispatch controller further coupled to a billing server via the communications network, the program instructions further including transmitting the facility power load signals and the power generator dispatch signal by the dispatch controller to the billing server via the communications network.

13. The dispatch controller of claim 11, the program instructions further including:
receiving power generator status signals by the dispatch controller from the power generator; and
transmitting the power generator status signals by the dispatch controller to the operations server via the communication network.

14. The dispatch controller of claim 11, wherein the dispatch controller is further coupled to a facility cooling demand meter, the program instructions further including:
receiving by the dispatch controller a facility cooling demand signal from the facility heat meter; and
generating the power generator dispatch signal by the dispatch controller using the facility power load signals, the generator fuel supply cost signal, and the facility cooling demand signal.

15. The dispatch controller of claim 14, wherein the dispatch controller is further coupled to a chiller, the program instructions further including:
generating a chiller dispatch signal by the dispatch controller using the facility power load signals, the generator fuel supply cost signal, and the facility cooling demand signal; and
transmitting the chiller dispatch signal to the chiller by the dispatch controller.

16. The dispatch controller of claim 11, wherein the dispatch controller is further coupled to an alternative power source and an alternative energy power meter, the program instructions further including:
receiving an alternative energy power generation signal;
generating an alternative power source dispatch signal by the dispatch controller using the facility power load signals, the alternative energy power generation signal, and the generator fuel supply cost signal; and
transmitting the alternative power source dispatch signal to the alternative power source.

17. A dispatch controller for managing power production for a facility over a communications network, the dispatch controller coupled via the communications network to an operations server and coupled to a facility power meter, a cogenerator, a facility cooling demand meter, and a chiller, the dispatch controller comprising:
a processor; and
a memory operably coupled to the processor and having program instructions stored therein, the processor being operable to execute the program instructions, the program instructions including:
receiving facility power load signals by the dispatch controller from the facility power meter;
receiving by the dispatch controller a facility cooling demand signal from the facility cooling demand meter;
receiving a cogenerator fuel supply cost signal by the dispatch controller from the operations server via the communications network;
generating a cogenerator dispatch signal by the dispatch controller using the facility power load signals, the facility cooling demand signal, and the cogenerator fuel supply cost signal;
generating a chiller dispatch signal by the dispatch controller using the facility power load signals, the cogenerator fuel supply cost signal, and the facility cooling demand signal;
transmitting the cogenerator dispatch signal by the dispatch controller to the cogenerator; and
transmitting the chiller dispatch signal to the chiller by the dispatch controller.

18. The dispatch controller of claim 17, wherein the dispatch controller is further coupled to a photovoltaic array and a photovoltaic array power meter, the program instructions further including:
receiving a photovoltaic array power generation signal by the dispatch controller from the photovoltaic array power meter;
generating a photovoltaic array dispatch signal by the dispatch controller using the facility power load signals, the photovoltaic array signal, and the cogenerator fuel supply cost signal; and
transmitting the photovoltaic array dispatch signal to the photovoltaic array.

19. A computer-readable medium embodying program instructions for execution by a controller, the program instructions adapting a controller for managing power production for a facility over a communications network, the controller coupled via the communications network to an operations server and coupled to a facility power meter and a power generator, the program instructions comprising:
receiving facility power load signals by the controller from the facility power meter;
receiving a generator fuel supply cost signal by the controller from the operations server via the communications network;
generating a power generator dispatch signal by the controller using the facility power load signals and the generator fuel supply cost signal; and
transmitting the power generator dispatch signal by the controller to the power generator.

20. The computer-readable medium of claim 19, the controller further coupled to a billing server via the communications network, the program instructions further comprising transmitting the facility power load signals and the power generator dispatch signal by the controller to the billing server via the communications network.

21. The computer-readable medium of claim 19, the program instructions further comprising:
receiving power generator status signals by the controller from the power generator; and
transmitting the power generator status signals by the controller to the operations server via the communication network.

22. The computer-readable medium of claim 19, wherein the controller is further coupled to a facility cooling demand meter, the program instructions further comprising:
receiving by the controller a facility cooling demand signal from the facility heat meter; and
generating the power generator dispatch signal by the controller using the facility power load signals, the generator fuel supply cost signal, and the facility cooling demand signal.

23. The computer-readable medium of claim 19, wherein the controller is further coupled to a chiller, the program instructions further comprising:
generating a chiller dispatch signal by the controller using the facility power load signals, the generator fuel supply cost signal, and the facility cooling demand signal; and
transmitting the chiller dispatch signal to the chiller by the controller.

24. The computer-readable medium of claim 19, wherein the controller is further coupled to an alternative power source and an alternative energy power meter, the program instructions further comprising:
receiving an alternative energy power generation signal;
generating an alternative power source dispatch signal by the controller using the facility power load signals, the alternative energy power generation signal, and the generator fuel supply cost signal; and
transmitting the alternative power source dispatch signal to the alternative power source.
